(19) United States
(12) Patent Application Publication
(10) Pub. No.: US 2007/0120856 A1
(43) Pub. Date: May 31, 2007

(54) Method and system for organizing content on a time axis

(75) Inventors: Boris Emmanuel Rachmund De Ruyter, Neerpelt (BE); Natalia Andrea Romero Herrera, Eindhoven (NL); Joy Karen Van Baren, Amsterdam (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS. N.V., Eindhoven (NL)

(21) Appl. No.: 10/577,397

(22) PCT Filed: Oct. 25, 2004
(86) PCT No.: PCT/IB04/52198

§ 371 Date: Apr. 27, 2006

Related U.S. Application Data
(60) Provisional application No. 60/516,430, filed on Oct. 31, 2003.

(51) Int. Cl. G06T 11/20

(52) U.S. Cl. 345/440

(57) ABSTRACT

A method and system are provided for organizing content on a spiral time axis. Content is organized on the spiral axis, for example, based on the creation date or reception time of the corresponding content. More recent content can be positioned, for example, towards the outside of the spiral while older content is positioned towards the inside of the spiral. Properties of the content representation can optionally be specified to convey additional information about the content. An efficient means for responding to communications from other friends and family members is also provided.

The present invention relates to methods and systems for managing and organizing content, and more particularly, to a method and system for organizing content on a time related axis by means of a spiral to facilitate computer-mediated communications.

As the members of family grow up and increasingly become distributed in time and place, for example, due to a child moving away for educational or work purposes, the need for the family to be able to effectively communicate becomes very important. When time of distance limits the frequency of face-to-face meetings, people must rely on mediated communication to maintain and strengthen their relationships.

In addition to traditional communication tools such as the telephone, letters, and postcards, new technologies have provided people with a variety of media to bridge geographical distances. Computer-mediated communication tools, such as electronic mail and Instant Messaging, have quickly gained popularity and are now widely used. Research, however, has indicated that despite the availability of all these different communication tools, there is still a great need to enhance the communication between family members who live apart. For example, family members and friends need to organize and access the communications between one another, including media in the form of documents, pictures, graphics, audio and video recordings.

A number of Content Management Systems are available that list content in a text format according to bibliographic information, such as title, author, and creation date. In addition, there are systems that organize content according to metadata, including thumbnail images arranged in a grid, wherein each thumbnail image represents a picture or segment of video. While these systems provide a mechanism for organizing content, they do not convey enough information in a format that fosters the quick and accurate retrieval of the desired content and do not provide a friendly, easy-to-use mechanism for replying to family communications. A need therefore exists for a method and system for organizing content on a time axis.

Generally, a method and system are disclosed for organizing content on a spiral time axis. Content is organized on the spiral axis, for example, based on a creation, reception or modification time of the corresponding content. The disclosed method and system enables users to communicate with one other in an efficient and personally fulfilling manner through the use of computer-mediated communications.

In one variation, more recent content is positioned towards the outside of the spiral while older content is position towards the inside of the spiral. Furthermore, properties of the content representation, including size and color coding, can optionally be specified to convey additional information about the content. The method and system also provides an efficient means for responding to communications from other friends and family members.

A more complete understanding of the present invention, as well as further features and advantages of the present invention, will be obtained by reference to the following detailed description and drawings.

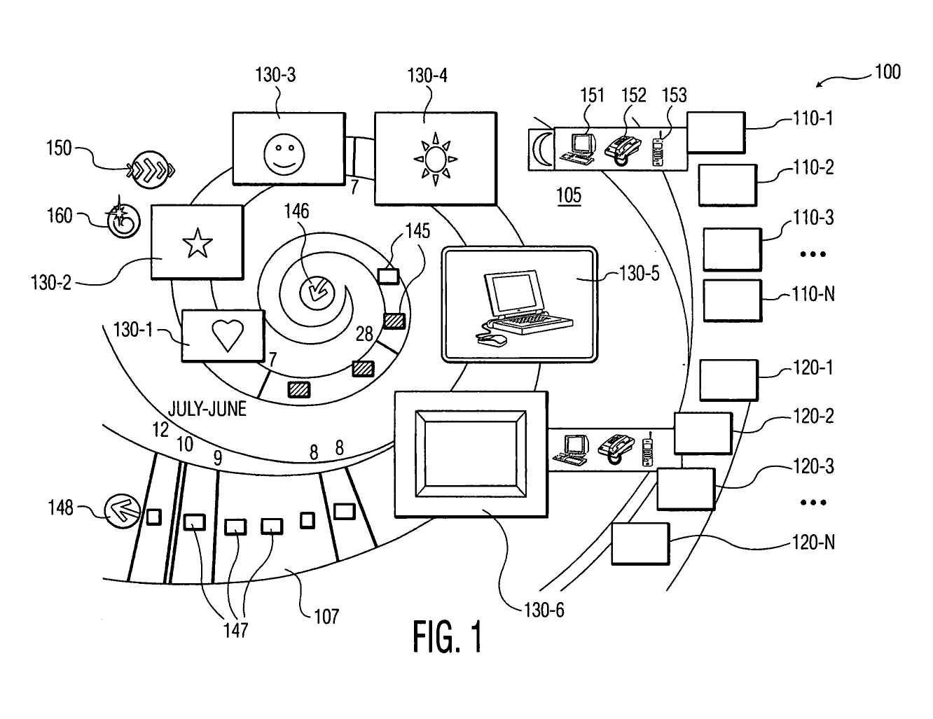

FIG. 1 illustrates a spiral representation of content that incorporates features of the present invention;

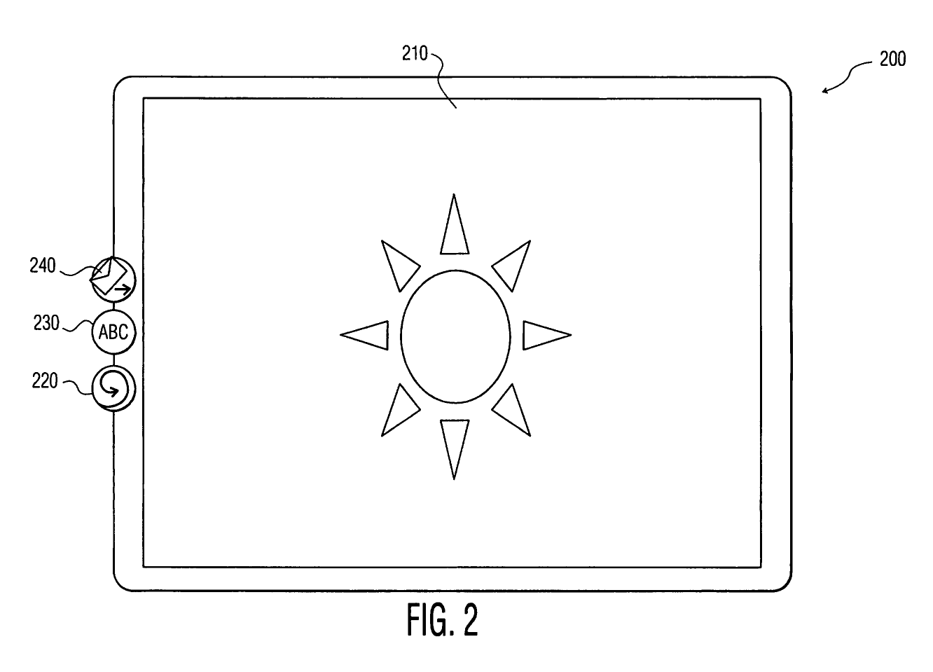

FIG. 2 is a full screen view of a selected content item of FIG. 1;

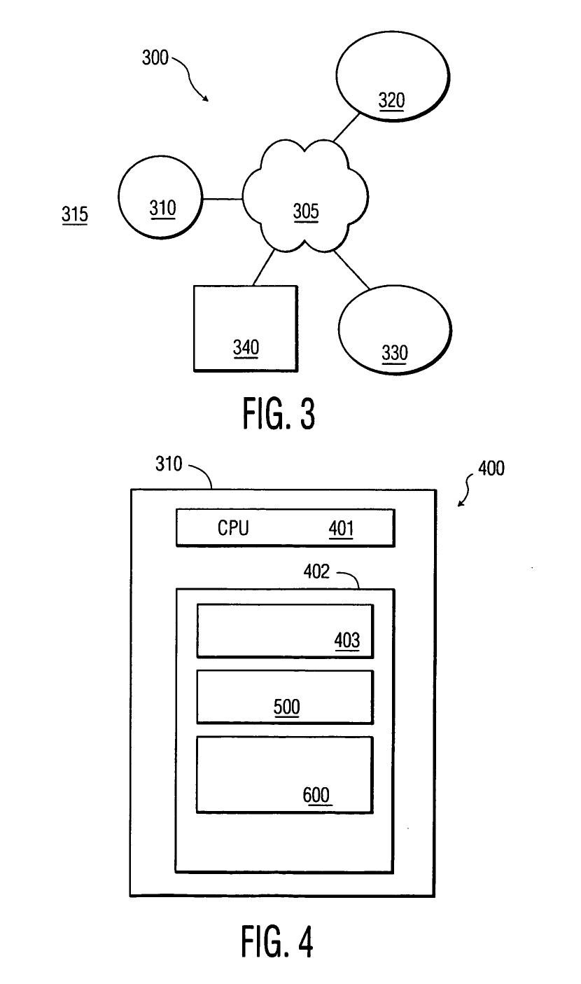

FIG. 3 illustrates the network environment in which the present invention operates;

FIG. 4 is a schematic block diagram of the content presentation client of the present invention;

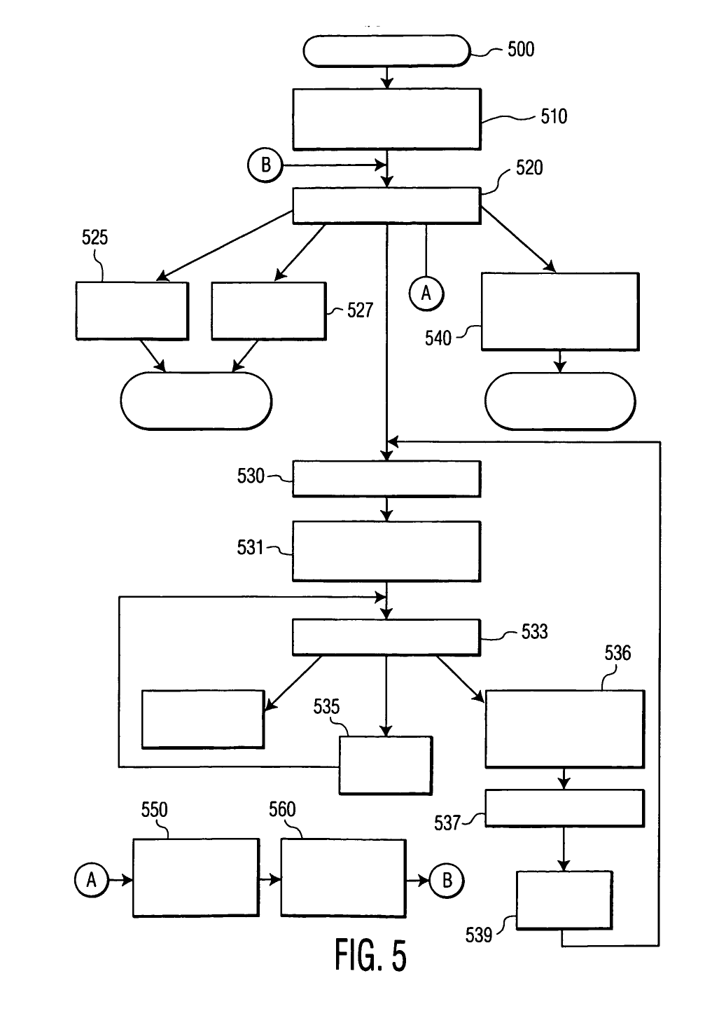

FIG. 5 is a flowchart describing an exemplary implementation of the system process of the content presentation client of FIG. 4; and

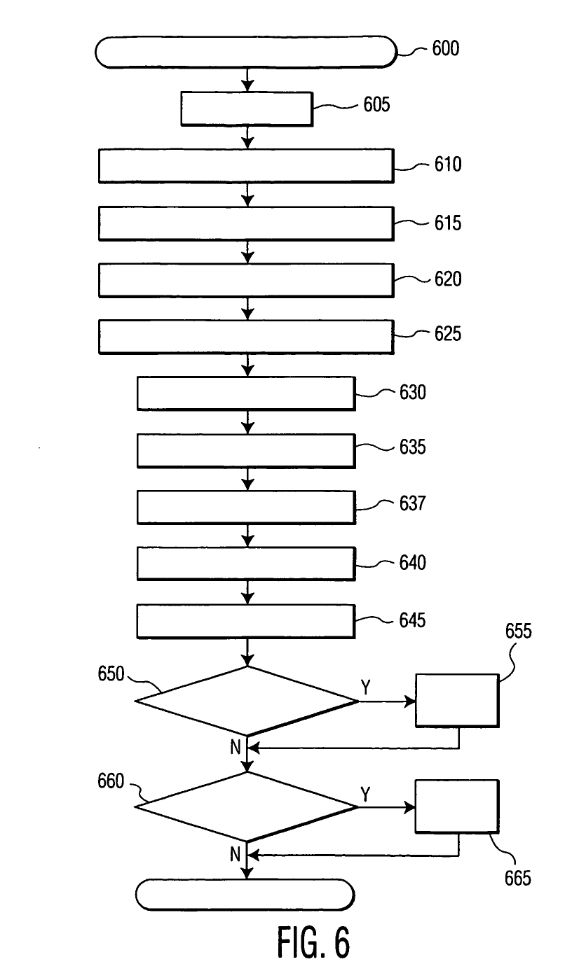

FIG. 6 is a flowchart describing an exemplary implementation of the spiral presentation process of the content presentation client of FIG. 4.

The computer-mediated communications of the present invention utilizes a postcard as a metaphor for providing efficient, but personal communication between family members of a household. A postcard allows users to share concrete visual cues of daily events and provides a personal touch that is meaningful to the receiver. A postcard provides a means for sharing concrete visual cues (pictures) with the possibility to add short handwritten notes. In addition, a post card is seen as a meaningful way to communicate when compared to other current mediums. In consequence, if a mobile user wishes to communicate with another family member or friend, the information captured should consist of a picture and a handwritten note. On the receiving side, the user needs to have a friendly, comfortable mechanism for organizing and viewing content sent by a multitude of friends and family.

FIG. 1 illustrates a spiral time line 100 for presenting content that incorporates features of the present invention. An axis 105 in the form of a spiral is used to present icons 130-1 through 130-N representing one or more content items, such as messages or documents, in a particular order. In this example, the icons at the center of the spiral 105 represent messages with the earliest creation times and each successive icon on the spiral represents the messages with the next latest creation date. In addition, since the messages with the most recent creation date are generally most relevant, the size of the icons can be inversely proportional to the amount of time since the message's creation time.

The three-dimensional effect created by the spiral and size variations aid the viewer in focusing on the most recent content items, such as pictures or messages, while still being able to view older content. The time-based visualization without a fixed scale saves space and provides for scalability while giving smooth transitions on a continuous timeline.

The spiral axis 105 may also be separated into segments, such as the segment 107, wherein each segment 107 represents a specific range of the parameter used to organize the messages, such as time. For example, spiral 105 can be segmented according to time periods 107, wherein each segment 107 represents one day. It should be noted that the segmentation of the spiral 105 may be completed in either a linear fashion (each segment represents the same period of time) or non-linear (each segment represents a different period of time). In addition, the length of the segment 107 can be chosen to be proportional to the amount of time represented by the segment 107.

In one alternative embodiment, a zoom feature is also provided to enable a user to zoom in on a particular area or segment 107 of the spiral 105 and view that portion of the spiral 105 at a higher resolution. In cases where the number of messages for a particular segment 107 is too high to display an icon 130 for each piece of message, the zoom feature will also allow the user to view icons not visible in the normal view.

According to one aspect of the invention, a spiral 105 gives a three dimensional effect to combine a detailed view (present pictures) with a compressed view (cues to past and future pictures). This avoids an overload of information while presenting as much information as possible. Basically, the three related time frames represented in the spiral allow a user to focus the attention on a limited set of N visible pictures (such as six in the exemplary embodiment) but at the same time give an overview of what there is after and before that frame. Two arrows 146, 148 (one on each extreme of the spiral) allow stepping between the three time frames by group of six pictures.

According to another aspect of the invention, the size of a picture serves as a visual cue for its recency to help the visualization of time relation between the visible pictures. In addition, in order to support scalability (different frequencies of use), there is no fixed time frame predefined, e.g., a week view or a day view. Instead, the use of dynamic date separators focuses the display on the pictures available rather than on a specific time frame. It also provides a date relation between pictures and allows users to unevenly step to different time frames (other than by a group of six). This makes the visualization more flexible, avoids empty spaces and provides a continuous timeline with smooth transitions.

In various implementations, a number of awareness representations can be included to augment the visualization:

For example, to link the exchanged information (such as pictures) with the sender and receiver, a color code and two different spaces (shared 110 and personal 120) can be used. The color code used on the borders of the user icons 110, 120 identifies the sender of a picture and gives an awareness of her/his activity. The shared and personal spaces 110, 120 provide cues of who is the receiver of the pictures displayed.

In addition to the information given by the user icons 110, 120, reachability information 151, 152, 153 is provided to show by which means users are currently reachable for communication. In one implementation, a reachability status (available or unavailable) is provided to indicate the corresponding user's reachability at three exemplary types of communication: instant messaging 151, telephone at home 152, and mobile phone 153. In other embodiments, this information is automatically captured and presence information is provided in other ways, such as status (online, away, busy or offline) and location.

Finally, a slideshow mode can optionally be provided as a way to explicitly change from an active mode to a pre-attentive background mode.

Graphical User Interface

The exemplary graphical user interface presents three types of views:

1. A spiral view (see FIG. 1) serves as a passive or active display for the user to see and interact with the information captured. The information displayed consists of content, such as pictures or drawings and text notes made on, for instance, a mobile device.

2. A full screen view (see FIG. 2) provides a zoomed view of a selected content item, such as a picture or drawing, along with exemplary options to reply or to display the attached text note if one exists.

3. A slide show view is a passive display that shows a sequence of content that are currently contained in the spiral.

In both the spiral and slide show view, an icon can appear whenever a new picture has been received.

In one exemplary implementation, two classes of users, such as members of a host household and a guest household, are created to control the interaction between the different households from a graphic point of view. The host household represents a family that owns a homebound (client) device, while the guest household represents a family that the host household wants to communicate with. For example, if household A and household B are using the system, house A is the host household when accessing the system from house A's device; house A is the guest household when accessing the system from house B's device.

### Spiral View

In the exemplary spiral view shown in FIG. 1, a user can check pictures in a shared space or in a personal space. The exemplary system displays by default the shared space of the household where all messages that have been sent to the members of that family are shown. After a user presses her/his own user icon 110, 120, the system changes the content of the spiral to show the messages that have been sent to that particular user only. The spiral interface 100 allows the user to browse backwards and forwards (time-based navigation) in groups of N pictures at a time displayed in the spiral representation. The user can also enlarge a picture to a full view screen (FIG. 2). An additional feature of the spiral interface 100 allows a user to activate a “to-tell” list by pressing on the picture of any of the guest members. A to-tell list displays only those messages that have not yet been responded to.

As shown in FIG. 1, the spiral view 100 contains three interactive areas that convey different information to the user: the spiral 105 for displaying the content, the host area 110 to interact with information of the owner of the device, and the guest area 120 to interact with the other household.

Spiral 105

In the spiral 105, the user finds several elements that provide a complete view of the messages that have been sent. The spiral is divided into three areas of interaction: the beginning part (lower left part of the spiral 105) where a set of N colored squares are displayed as a cue of later messages in relation to the focus area (central part of the spiral 105), the focus area where the current N messages are presented in different size based on the creation or reception time, and the end part where another set of N colored squares serve as cue of earlier messages. Both ends are useful while browsing to give an idea of how full the system is.

The spiral 105 offers two ways for browsing. One is by using the arrows 146, 148 located at each end of the spiral 105 (a first arrow 148 means ‘future’ and a second arrow 146 means ‘past’) which the user can use to browse previous or later messages relative to the six messages in the focus area. This type of browsing is done by groups of N messages/pictures. A second way of browsing is by using the dividers to separate messages that belong to different days. Touching a divider brings the message that follows that divider to be the first message in the focus area, thus updating the time frame of the focus area and changing the content of the spiral.

Host Household 105

Pictures placed in the upper right area of the screen represent the host members 110. In this area, the owners of the device can identify themselves by pressing on her/his user icon 110-n to go to their personal area. FIG. 2 shows feedback indicating that a given user is logged in. In this area, users can activate a filter to display a to-tell list. Users can also check and set their own reachability information by pressing the reachability icon 151, 152, 153 next to her/his user icon 110-n. The reachability information tells other users which modes of communication can be used to contact the individual and which modes are the best modes for this purpose.

Guest Household 120

Pictures placed in the lower right corner of the screen represent the guest members 120. In the personal area, the logged in user can activate a to-tell list by pressing on the user icon 120 of a guest user. Also, in both the shared and personal spaces, the user can display the reachability information of a guest member. To accomplish this, the icon next to the picture of that user has to be pressed. In the spiral view 100 (FIG. 1), an icon 150 activates the slideshow mode and an icon 160 gives feedback when a new message arrives.

Full Screen View

FIG. 2 is a full screen view 200 of a selected content item of FIG. 1.

In the full screen view 200, senders can see a reply attached to a sent message. This is generally done only in the personal area and when a filter (to tell-list) is activated. In addition, receivers can see attached text or can reply with a drawing or handwritten note to that message.

A colored-border can display the message selected in the spiral. As shown in FIG. 2, the exemplary full screen view 200 provides a reply function 240, a text function 230 and a return function 220. The text icon 230 displays the text if the sender has sent it along with the picture. The return icon 220 brings back the spiral view 100. The reply icon 240 has two functions depending on whether the receiver or sender is viewing the content. For receivers, the reply icon 240 allows a user to draw a short note to send as a response to the sender; for senders, the reply icon 240 displays the reply if one exists.

FIG. 3 illustrates a network environment 300 in which the present invention operates. As is illustrated in FIG. 3, the network environment 300 includes a client 310, presence server 320, and e-mail server 330. In this manner, the client 310, discussed further below in conjunction with FIG. 4, can interact with the an e-mail server 330 to present content to a user 315 using a spiral interface 100 in accordance with the present invention.

The client 310 provides a graphical user interface for displaying the spiral-based content management system of the present invention and for executing commands requested by a user. The presence server 320 maintains a database regarding the current status of users in the system, including the status of the user of the client 310, in a known manner. The e-mail server 330 receives, transmits, and manages e-mail messages from a number of host family members 110-1 through 10-N and guest family members 120-1 through 120-N (collectively referred to as family members 110 and family members 120, respectively), including the user 315 of client 310. The e-mail server 330 processes e-mail messages consisting of media in the form of text, documents, pictures, graphics, audio and video recordings.

The presence server 320 server plays the role of the server and a Java API Client plays the role of the desktop client. The presence server 320 may be embodied as a Mobile Presence Platform (MPP) component of a Mobile Presence Application (MPA), which provides all the necessary communication services. Communities and community members are the main concepts supported by presence server 320. It also provides services in order to use the server as a standard presence and instant messaging (IM) platform.

The implementation consists of a Java API for a desktop client in order to connect the household device with the server. The Java API listens to all the services that the presence server 320 provides and presents them in terms of the graphic interface. The Java API also handles the user interaction and sends the right requests to the servers 320 and 330.

The Java API Client performs the following functions:

1. Show messages in shared and personal areas 120, 110. This provides a way to access personal areas where no explicit log in action should be required. The main implication is that privacy protection of family members will rely on social control.

2. Provide three modes of visualization: spiral, full screen and slideshow mode. This works as an easy and smooth transition between detailed and overview information, but implies some restriction with regards to scalability and personalization (only four members per family group, only two families, and the color-map is predefined).

3. Provide feedback in the full screen mode if the message has text or a reply attached. Display that text or reply when the user asks for it.

4. Provide a way to respond to a message by writing a short text or creating a drawing. The sender of the message in his homebound device can only see the reply of that message. This functionality provides a simple solution to support two-way communication.

5. Provide a way to check the reachability information of a user.

6. Provide a way to change the reachability information of the logged on user.

The mobile client 340 sends messages capturing concrete cues of daily events (pictures or handwritten notes) to one or more family members of the other household. No notification or presence information is received from the other side (household). To simplify the implementation of the client, an off-the-shelf e-mail client application for a mobile phone may be used (thus only an e-mail interface is needed to communicate to a number of POP accounts to the MPA server). Thus, the graphic interaction with the mobile phone is not integrated as part of the GUI of the homebound device. It is basically a set of steps to compose a normal e-mail message.

Generally, the tasks supported by the presence server 320 are:

1. Notification when new messages arrive.

2. Retrieve the collection of messages that belong to a specific community.

3. Retrieve reachability information of users.

4. Change personal reachability information.

5. Attach a reply to a message and retrieve it when is requested.

The client 310 is discussed further below in conjunction with FIG. 4. Generally, the functions supported by the client 310 are:

1. Insert pictures sent by the mobile device 340 into the spiral 105.

2. Update the spiral 105 according to the current set up of the user (shared or personal space, to-tell list, browsing backwards and forwards).

3. Provide a slideshow mode with the current pictures shown in the spiral.

4. Provide a full screen mode to maximize a selected picture.

5. Provide a reply from homebound device to homebound device to respond to the selected picture.

6. Provide an option to manually set the reachability information of a user and an option to display personal or other user's reachability information.

7. Provide visual feedback indicating the current status of the system (what is active) and when a new picture is inserted.

8. Provide visual representations of time relations between pictures, relations between picture and sender and cues of how busy the system is.

FIG. 4 is a schematic block diagram of the client 310 of FIG. 3. As is known in the art, the methods and apparatus discussed herein may be distributed as an article of manufacture that itself comprises a computer-readable medium having computer-readable code means embodied thereon. The computer-readable program code means is operable, in conjunction with a computer system such as central processing unit 401, to carry out all or some of the steps to perform the methods or create the apparatuses discussed herein. The computer-readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk.

Memory 402 will configure the processor 401 to implement the methods, steps, and functions disclosed herein. The memory 402 could be distributed or local and the processor 401 could be distributed or singular. The memory 402 could be implemented as an electrical, magnetic or optical memory, or any combination of these or other types of storage devices. The term “memory” should be construed broadly enough to encompass any information able to be read from or written to an address in the addressable space accessed by processor 401.

As shown in FIG. 4, the memory includes content and message data 403, a system process 500 and a spiral presentation process 600. The content and message database stores the content, such as messages in the exemplary embodiment, that are presented to the user in the spiral interface 100. The content and message data 403 provides access to the content for each user, which may be stored locally or remotely (or a combination thereof), as would be apparent to a person of ordinary skill in the art. When the content is stored remotely, such as an on email server 330, the content and message data 403 would include, for example, data structures for the dynamic management of the email messages, including account information.

FIGS. 5 and 6 are flowcharts illustrating the processes executed by the client 310. The client 310 executes system process 500 and, initially, executes the spiral presentation process 600, as discussed further below in conjunction with FIG. 6, during step 510 to display the communications received by the family members 110. The system process 500 then waits during step 520 for a command to be entered by the user 315.

During step 520, the system process 500 waits for the user 315 to enter a command. If the user wishes to view the messages created earlier then those displayed on the spiral 105, then the user 315 presses on the arrow 146; if the user wishes to view the messages created later then those displayed on the spiral 105, then the user 315 presses on the arrow 148. The process 500 then executes either step 525 or step 530, respectively. If step 525 is executed, the process 500 decrements the message display group parameter by N and the process 500 continues with step 630 of process 600, discussed below. If step 527 is executed, the process 500 increments the message display group parameter by N and the process 500 continues with step 630 of process 600 (FIG. 6). In addition, a user can browse messages by touching a date divider 107 on the spiral interface 100 in order to step through the messages according to the divider position.

If during step 520, the user 515 presses on one of the N displayed e-mail message icons 130, the process 500 will execute step 530. During step 530, the process 500 retrieves the e-mail message associated with the pressed message icon 130 from the e-mail server 330. The process 500 then displays a full screen view (FIG. 2) of the picture included in the e-mail message and displays three exemplary command icons: a reply function 240, a text function 230 and a return function 220, as illustrated in FIG. 3 (step 531). The process 500 then waits for the user 315 to enter a command by pressing one of the command icons (step 533). If the user 315 presses the return function icon 220 (spiral), the process 500 continues with step 610 of process 600. If the user 315 presses the text function icon 230, the process 500 overlays the text message from the associated e-mail message on the full screen view of FIG. 2 (step 535) and continues with step 533. If the user 315 presses the reply function icon 240, the process 500 displays a message composition window and transmit icon to enable the user to compose a response message to the sender of the present e-mail message (step 536).

The process 500 then executes step 537 and waits for the user 315 to complete the message composition and press the transmit icon. When the user 315 presses the transmit icon, the process 500 transmits the composed message to the e-mail server 330 (step 539) and returns to step 530.

During step 520, if the user 315 presses and holds an icon 110 representing a family member of the user's household, the process 500 then retrieves the list of e-mail messages addressed to the family member associated with the pressed icon 110 from the e-mail server 330 (step 540). In a further variation, the action performed during step 540 can retrieve email messages from the server 330 for host members 110 and only filter messages for a remote or guest member 120.

The process 500 then continues by executing step 635 of process 600 (FIG. 6).

During step 520, if the user 315 presses and holds an icon representing a family member 110, 120, the process 500 then retrieves the reachability information for the family member associated with the icon from the presence server 320 (step 550). The process 500 then creates and displays three communications icons (e-mail 151, telephone 152, and mobile phone 153) that provide reachability information indicating whether the family member is available by the associated form of communication. In addition, the process 500 preferably provides a mechanism to allow the user to manually update their reachability information and set the presented reachability status accordingly. The process 500 then returns to step 520 and continues in the manner described above.

FIG. 6 is a flow chart describing an exemplary embodiment of the spiral presentation process 600. The process 600 first initializes the message display group parameter to N indicating that the first group of e-mail messages should be displayed on the spiral 105 (step 605). The process 600 then retrieves the list of family members in the household of the user 315 along with the picture (or user icon) and optional color code associated with each family member (step 610). During step 615, the process 600 creates and displays an icon 110 of each family member discovered during step 610. Each icon 110 optionally consists of a picture of a family member surrounded by a color border whose color matches that associated with the family member. The process 600 then retrieves the list of family members in another household along with the picture and color code associated with each family member (step 620). During step 625, the process 600 creates and displays an icon 120 of each family member discovered during step 620. Each icon 120 also consists of the picture of a family member surrounded by a color border whose color matches that associated with the family member.

The process 600 then retrieves the list of e-mail messages addressed to the family members 110 from the e-mail server 330 (step 630). The list of e-mail messages includes the name of the sender, a thumbnail picture, the creation time of the message and the time at which the e-mail server 330 received the message. The list of e-mail messages is sorted by the e-mail server 330 according to the creation time of each message.

The process 600 then selects the current one of the N messages from the list of e-mail messages (step 635). The number of messages selected and displayed may be statically or dynamically selected according to the desired image resolution as would be apparent to one of ordinary skill in the art.

During step 637, the process 600 then displays a spiral 105 segmented into time periods 107 appropriate for the range of creation times of the messages selected during step 635. For instance, if the messages selected during step 635 were created on the same day, each segment 107 of the spiral 105 may represent four hours. Alternatively, if the messages selected during step 635 were created during a seven-day period, each segment 107 of the spiral 105 may represent one day.

For each message identified in the list of step 635, the process 600 creates an icon 130 consisting of the thumbnail picture surrounded by a colored border (step 640). The color of the border is selected to match the color assigned to the sender (as designated during step 610 and 620). Each icon 130 is then placed at the point of the spiral 105 that is associated with the creation time of the message represented by the icon 130 (step 645).

The process 600 then performs a test during step 650 to determine if the list of e-mail messages contains messages created earlier then the N messages selected during step 635. If it is determined during step 650 that there are no messages created earlier then the N messages selected during step 635, then the process 600 continues with step 660; otherwise the process 600 displays the cues 145 indicating that there are messages created earlier than those on display (step 655). The process 600 then continues with step 660.

During step 660, the process 600 then performs a test to determine if the list of e-mail messages contains messages created later then the N messages selected during step 635. If it is determined during step 660 that there are no messages created earlier then the N messages selected during step 635, then the process 600 continues with step 520 of process 500; otherwise the process 600 displays the cues 147 indicating that there are messages created earlier than those on display (step 665). As previously indicated, the user can optionally browse messages by selecting a desired time interval 107. The process 600 then proceeds with step 520 of FIG. 5.

Interaction Scenario

To provide an overview of the present invention and the interaction with the GUI, a full-story “interaction” scenario is described.

“Paul comes home after a busy day at work. He wants to see whether there are any messages for him, so he touches the homebound device. The homebound device, which was in the slideshow mode, starts up in the family shared area.

The family shared area shows a spiral that contains six pictures scaled in size in a time order, the same order in which they were sent to Paul's household. By the color of the borders of the pictures, he can see who has sent each message.

Paul decides to have a closer look at the second largest message in the spiral, so he presses on it to go to the full screen mode. In this mode, he can see the picture in a larger size. At the left side of the screen, there are three icons, which can be bright color or gray. He sees that the icon of the text message is enabled (bright blue color), so he touches it to read the text sent along with the picture. After he has read the message, he wants to respond to it. He touches the reply icon, writes a short note, and then presses the ok icon. Afterwards, he goes back to the spiral mode by pressing the return icon.

The family shared area also shows pictures of the members of both households. In the right upper corner, Paul sees his own household and, in the right lower corner, the other household. Each person has his/her own border color on their picture that matches the border color of the messages in the spiral that he/she sent. Next to each picture of the members of the other household is an icon that represents the reachability icon. By pressing it, Paul sees how he can most likely reach the other person. He presses the icon of his brother Carlo and sees three symbols: a computer that is white colored, a fixed phone that is gray, and a mobile phone that is also white colored. This means that Carlo is more likely to be reachable by an instant messaging application or by mobile phone.

In addition to the six pictures, the spiral provides two more areas to represent messages: two sets of six small colored squares (cues) at the beginning (left bottom corner) and at the end (centre) of the spiral. These cues indicate if there are messages either after or before the time frame of the six messages displayed in the central part of the spiral. Paul wants to see the previous six messages, so he presses the arrow icon placed in the centre of the spiral. The spiral then changes the time frame of the 6 scaled-size messages to show the previous six messages. He does the same to see the newest messages by pressing the arrow icon placed at the beginning of the spiral.

Now Paul wants to check the messages that have been sent only to him. By pressing his own picture, the system displays his personal area. What is more interesting for him is to see the messages that were recently exchanged between him and Carlo. He presses on Carlo's picture to activate the to-tell list between him and his brother. He wants to check if his brother has replied to some of the messages he has sent, so he presses the last message he sent to go to the full screen mode. The display indicates that the reply icon is active, so he presses it. A typical funny drawing made by Carlo is displayed followed by a note: “call you at 6”.

In his personal area, Paul can also set his own reachability information by pressing the reachability icon next to his own picture. He indicates that he can only be reached by fixed phone by pressing once on the fixed phone icon.

Suddenly, the new message icon is displayed indicating that a new message is now shown in the first position of the spiral. Paul immediately knows that it is from his niece Gabi by looking at the coloured border of the picture and notes that it is a drawing of a big slice of pizza. He activates the to-tell list of Gabi and remembers that she is coming this evening to tell stories about her last holidays and to explain in more detail about all the pictures she has been sending to them. So Paul knows what the drawing means: that he has to prepare his famous home made pizza for this evening.

Before going to do some shopping, he puts the screen back to the shared area by pressing again on his own picture. Then he presses on the slideshow icon to activate the slideshow mode. The display shows in sequence all messages sent to the shared area as a decorative background.”

This scenario illustrates most functions of the system and illustrates how it can support family members to stay in touch by means of an awareness system based on asynchronous communication.

It is to be understood that the embodiments and variations shown and described herein are merely illustrative of the principles of this invention and that various modifications may be implemented by those skilled in the art without departing from the scope and spirit of the invention.

1. A system for presenting one or more content items to a user, comprising:
a spiral image; and
one or more icons arranged on said spiral image, each icon corresponding to one of said one or more content items, wherein a position of said icon on said spiral image indicates a relative position of said one or more content items in relation to other content items.

2. The system of claim 1, wherein a color of at least a portion of said icon associates said content item with one or more users or other content items.

3. The system of claim 1, wherein said spiral image is segmented into segments, wherein each segment represents a range of values of said relative position.

4. The system of claim 1, wherein said relative position is based on a creation time of said content item.

5. The system of claim 1, wherein said relative position is based on a reception time of said content item.

6. The system of claim 1, wherein said relative position is based on a modification time of said content item.

7. The system of claim 1, wherein said content item is a message.

8. The system of claim 1, wherein said content item is a document.

9. The system of claim 1, wherein a size of a plurality of said icons is proportional to said relative position.

10. The system of claim 1, wherein a first plurality of said icons is presented with a detailed view while at least a second plurality of said icons is presented with a compressed view.

11. The system of claim 1, further comprising an indication of a reachability of at least one user associated with a given content item.

12. A method for presenting one or more content items to a user, comprising:
Generating a spiral image having a center and an endpoint; and
Arranging one or more icons on said spiral image, each icon corresponding to one of said one or more content items, wherein a position of said icon on said spiral image indicates a relative position of said one or more content items in relation to other content items.

13. The method of claim 12, wherein a color of at least a portion of said icon associates said represented content item with one or more users or other content items.

14. The method of claim 12, wherein said spiral image is segmented into segments, wherein each segment represents a range of values of said relative position.

15. The method of claim 12, wherein said relative position is based on a creation time, reception time or modification time of said content item.

16. The method of claim 12, wherein a size of a plurality of said icons is proportional to said relative position.

17. The method of claim 12, wherein a first plurality of said icons is presented with a detailed view while at least a second plurality of said icons is presented with a compressed view.

18. The method of claim 12, further comprising an indication of a reachability of at least one user associated with a given content item.

19. A user interface for presenting one or more content items to a user, comprising:
a spiral image containing one or more icons, each icon corresponds to one of said one or more content items, wherein a position of said icon on said spiral image indicates a relative position of said one or more content items in relation to other content items; and
one or more tools to manipulate said one or more icons.

20. The user interface of claim 19, wherein said one or more tools includes a tool to access a content item associated with an icon.

21. The user interface of claim 19, wherein said one or more tools includes a tool to contact a user associated with an icon.

22. The user interface of claim 19, wherein said one or more tools includes a tool to navigate said spiral image.

23. The user interface of claim 19, further comprising a visual indication to associate one or more users with an icon.
